(19) United States
(12) Patent Application Publication
(10) Pub. No.: US 2012/0046975 A1
(43) Pub. Date: Feb. 23, 2012

(54) Rapid Insurance Market Segmentation and Savings Test

(76) Inventor: Robert Carl STOLZE, Buford, GA (US)

(21) Appl. No.: 13/215,780

(22) Filed: Aug. 23, 2011

Related U.S. Application Data
(60) Provisional application No. 61/376,126, filed on Aug. 23, 2010.

(51) Int. Cl. G06Q 40/08

(52) U.S. Cl. 705/4

(57) ABSTRACT

A computer method and system for quickly determining the competitive costs of a plurality of insurance companies for a consumer. The present invention provides the user with the means to input informational elements relating to their insurance profile. The insurance profile is then matched to a market segment with a plurality of insurance companies. The plurality of insurance companies within the market segment provides the needs most suitable for the matched insurance profile. An analysis of each insurance company's pricing is made in order to match a consumer insurance profile with an insurance company.

The current application claims a priority to the U.S. Provisional Patent application Ser. No. 61/376,126 filed on Aug. 23, 2010.

### FIELD OF THE INVENTION

The present invention relates generally to a computer method and system, more specifically, to a computer method and system for quickly determining a consumer's current Insurance Profile and for subsequently evaluating a consumer's opportunity to save money on their home and/or auto insurance.

### BACKGROUND OF THE INVENTION

The World Wide Web (WWW) is especially conducive to business-to-consumer two-way communications. In one direction, questions posed by consumers on the WWW can be quickly answered via internet services or search engines. In the opposite direction, business surveys can be posed to consumers to gather useful data to determine the likes and dislikes of consumers or to determine what product or service would be the best match or best fit for a consumer.

Business surveys conducted via the WWW can be simple or complex, short or extensive, and allow for consumer answers that are general or that require very specific answers.

On one end of the spectrum, simple, short, and general surveys can be completed in less than 1 minute. The ability to create a succinct, highly effective survey requiring less than one minute of time to complete is extremely important because it helps to maximize the consumer response/completion percentage, i.e., consumers will more often complete the survey if it doesn't take long to do.

On the other hand, complex, extensive, and specific surveys can take many minutes or hours to complete and are far less effective in getting consumers to complete them because the time commitment can be exorbitant.

A very common example of a complex, extensive, and specific business survey on the WWW is an auto insurance quote performed by an insurance company (“Insurer”). Because the result of the survey is a final insurance price quote, the consumer questions are numerous, detailed, and personal. These lengthy and detailed surveys are commonly advertised by Insurers via mass media outlets as “15 minute” processes but can often take as much as 30 minutes to complete. Appendix A illustrates an example of the numerous and detailed questions required in completing just one home and auto insurance quote from one Insurer.

It is this lengthy and detailed process that deters consumers from shopping widely and thoroughly for better pricing on their home and auto insurance.

But although consumers avoid shopping thoroughly for insurance value, there are plenty of Insurers to choose from. In fact, there are several dozen Insurers in most states (by way of example, my home state of Georgia currently has more than 65 different Insurers offering property and casualty insurance, e.g., home and/or auto insurance). Having such a large number of Insurers competing with one another has forced Insurers to be strategic in their marketing and pricing strategies. The various marketing and pricing strategies of Insurers have resulted in a very wide spectrum of pricing offered to a given consumer; in other words, pricing to a single consumer can vary significantly between Insurers for the same insurance coverage.

There are a couple primary reasons for this. The first of which is marketing related. Some Insurers market their product to specific groups or segments of people with specific risk and/or usage characteristics rather than target marketing everyone. For example, some Insurers offer very aggressive pricing to “low risk” individuals who have no recent history of accidents or violations and/or who have no claims against their homeowner's policy. Since home and auto insurance is regulated at the state level, this marketing segmentation process is also done at the state level.

The second primary reason relates to portfolio performance rebalancing. From an Insurer's perspective, and in its most fundamental sense, an Insurer's business objective is to bring in as-much or more money in insurance premiums (“Money-In”) than it pays out in claims and business expenses (“Money-Out”) by accurately forecasting and planning risk. Since home and auto insurance is regulated at the state level, this portfolio rebalancing process is also done at the state level.

As the ratios of Money-In to Money-Out fluctuate up and down due to the actual performance of risk versus its forecasted risk, insurance companies adjust consumer pricing. Pricing can be lowered to certain groups of people to attract more of them, and pricing can be raised to deter other groups. These pricing changes are often used to modify or rebalance the profitability or performance of their portfolio of consumer policies. In one example of rebalancing, an Insurer would raise rates in market segments whose actual performance represented higher risk than was originally forecasted, and the same Insurer would lower rates in market segments whose actual performance represented lower risk and was originally forecasted.

Regardless of the reason for the wide variation in pricing among Insurers, the fact remains that there are sizeable and numerous pricing improvement opportunities available to most consumers in the home and auto insurance marketplace. And the fact remains that the lengthy and detailed price quoting process aforementioned is a significant deterrent to a consumer rate shopping for these pricing improvement opportunities.

With the present invention, there is an opportunity to assist consumers by quickly finding consumers Insurers offering better value on their home and/or auto insurance without the consumer having to go through very lengthy and numerous price quotation processes. This can be completed by profiling/grouping/segmenting both Insurer pricing patterns and consumer risk and usage patterns in a very specific and symmetrical way and then matching like patterns together in order to “test” the profiles for savings opportunity.

### BRIEF DESCRIPTION OF THE DRAWINGS

FIG. 1 provides a conceptual overview of the end-to-end process including the 3 primary steps in completing a RIMSS Test. In step one, eight questions (of the total 10 questions shown) creates a consumer's Insurance Profile regarding the primary determinants of insurance usage and risk. The 9th question shown is used in Step 3, and the last question is simply for additional data collection. Profile answers from Step 1 result in the profile being placed into a Market segment in Step 2. In Step 3, the current insurer of consumer from Component J is compared to best priced insurer from the same market segment (is the current insurer the best priced one for the segment as shown in PAIPD?). The PAIPD is analyzed and the resulting Insurer pricing is ranked and segmented into the same Profile groupings as RIM Segmentation.

FIG. 2a to FIG. 2c provides a real world example of the 3-step process used in completing a RIMSS Test.

FIG. 3 provides a closer look at Step 1—Insurance Profile Creation. There are 10 data Components to be answered by a consumer most typically via the WWW. The collection of a set of answers to these 10 data Components constitutes the invention's specific Insurance Profile for a consumer.

FIG. 4 is a table of information providing supplemental information for each Component.

FIG. 5 provides a closer look at Step 2—RIM Segmentation. Illustrated is 6 possible insurance Market Segments to which a consumer's Insurance Profile could be placed. While there are numerous sub-Segments to the present invention, only 6 Segments are discussed herein for practical purposes.

FIG. 6a provides a closer look at Step 3—Current Cost Competitiveness Test. Illustrated are the results of the RIM Segmentation. Current insurer of consumer from step 1 (component J) is compared to the best priced insurer from same market segment as determined by PAIPD analytics to determine if the current insurer of consumer (Component J) equal the top ranked insurer for the segment as determined by PAIPD Analytics.

FIG. 6b illustrates the result of the collection, analysis, and Market Segmentation of PAIPD. PAIPD is analyzed and the resulting Insurer pricing is segmented into the same Profile groupings as in the corresponding RIM Segmentation step. The insurer average pricing by segment are then ranked from lowest average price to highest average price for each segment.

### DETAIL DESCRIPTIONS OF THE INVENTION

All illustrations of the drawings are for the purpose of describing selected versions of the present invention and are not intended to limit the scope of the present invention.

The present invention provides a method and system for quickly determining a consumer's fundamental insurance risk and usage profile by state. The insurance profile is rapidly placed into a typical grouping of insurance profiles or also known as an insurance market segment by state. The final step of the present invention is to test the insurance profile of a consumer for cost competitiveness in the home and auto insurance marketplace across the large pool of insurers by state. These three steps assisted the consumer by quickly finding an insurer with a high probability of low pricing for their specific insurance needs. The expedited automatic process prevents the need for spending hours or days in shopping and comparing insurance prices using individual and detailed quotes from many different insurers in their state of residence.

Insurance risk is determined by factors such as insurance claims history, credit score, etc. Insurance usage is determined by the amount of use and value of the items to be insured. The insurance risk and usage are primary determinants of insurance pricing for each state. The ability to quickly assess and gauge insurance risk and usage data elements can be a powerful tool in matching consumers to the insurers in their state offering aggressive pricing for the insurance profiles of the consumer in their respective market segments.

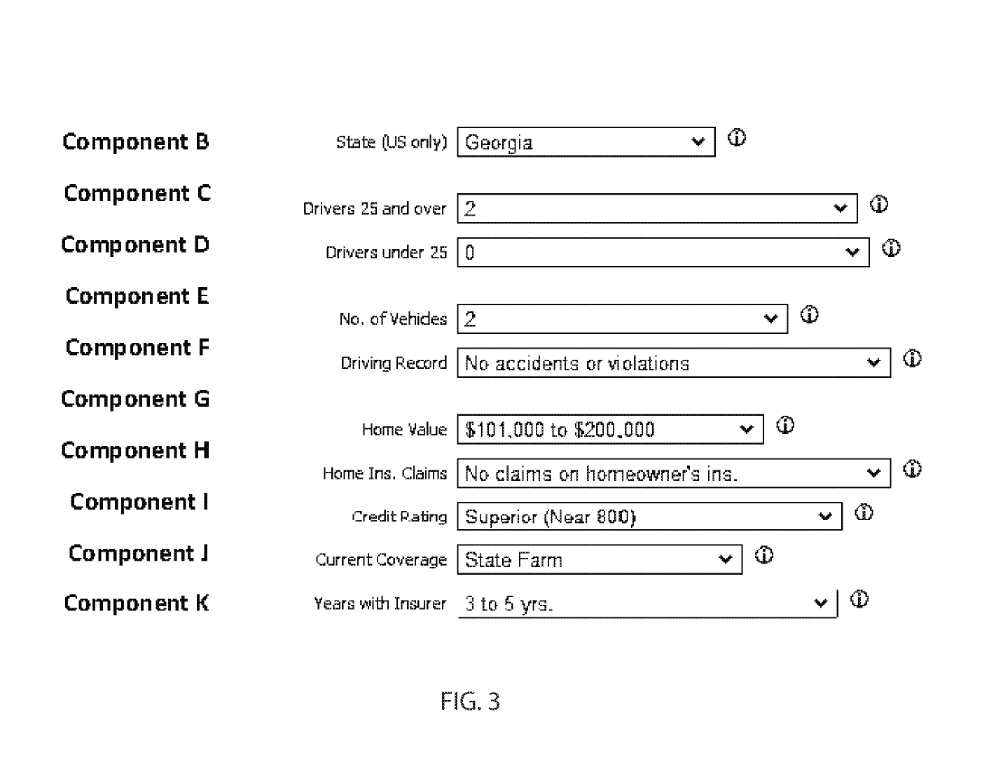

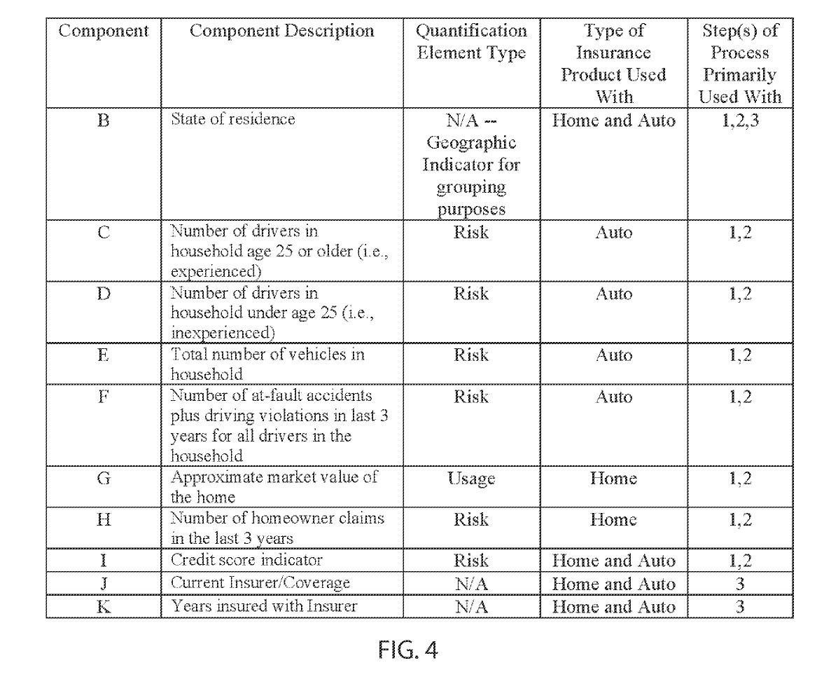

The first step of the present invention is the insurance profile creation step. The insurance profile creation step is used to gather information from the user. This information will determine the user's fundamental insurance risk and usage profile. In the preferred embodiment of the present invention, there will be no more than ten specific questions. Nine of the ten questions will be highly critical to the insurance profile and the tenth questions being the years with insurer being less critical. The insurance profile creation step is performed by prompting and receiving inputs by a client computer system and browser on the world wide web (WWW). This method is the preferred method of retrieving information from the user as it is the quickest and most ubiquitous method available. The determination of a consumer's insurance profile can be accomplished under a minute in a highly effective manner with ten specific questions. These ten specific questions prompt the user for a plurality of informational elements. The plurality of informational elements define a insurance profile. Eight of the nine questions prompt the user for important quantification element of risk for auto and/or home insurance. The values retrieved from the client are categorized under a plurality of auto elements and a plurality of home elements. The insurance risk and usage are the two primary expenses of insurers and are therefore large factors in determining insurance pricing for consumers. In reference to FIG. 3, the insurance profile creation step prompts the user for an information component B, a component C, a component D, a component E, a component F, a component G, a component H, an information component I, an information component J, and an information component K. The information component B prompts the user for the state of residence and is needed to define the geographic footprint of the consumer since home and auto insurance is regulated by state. The components C through F are primarily used for determining auto insurance and the components G and H are primarily used for determining home insurance. The component C prompts the user for the number of drivers under the insurance profile that are over the age of 25. The component D prompts the user for the number of drivers under the insurance profile that are under the age of 25. The component E prompts the user for the number of vehicles that are registered under the insurance profile. The component F is the number of at-fault accidents and driving violations within the last three years of the entire household recorded on the insurance profile. The component G prompts the user for the value of the home registered under the insurance profile. The component H prompts the user for the number of claims made for the home within the last three years the home was under the insurance profile. The information component I prompts the user for the credit score rating of the insurance profile. The information component J prompts the user for the current insurance policy coverage of the insurance profile. The information component K is the number of years the user is insured with their current coverage. In reference to FIG. 4, these components are used throughout the process to help the user determine the insurer that best fits their insurance needs with the lowest cost.

Being that the components prompted for by the present invention only focuses on the nine primary determinants of insurance pricing, the first step can be accomplished in less than one minute. This represents a significant improvement over the typical data collection process required by most insurers that prompt the user with dozens of questions before providing evidence of the insurer's pricing competitiveness in the market place.

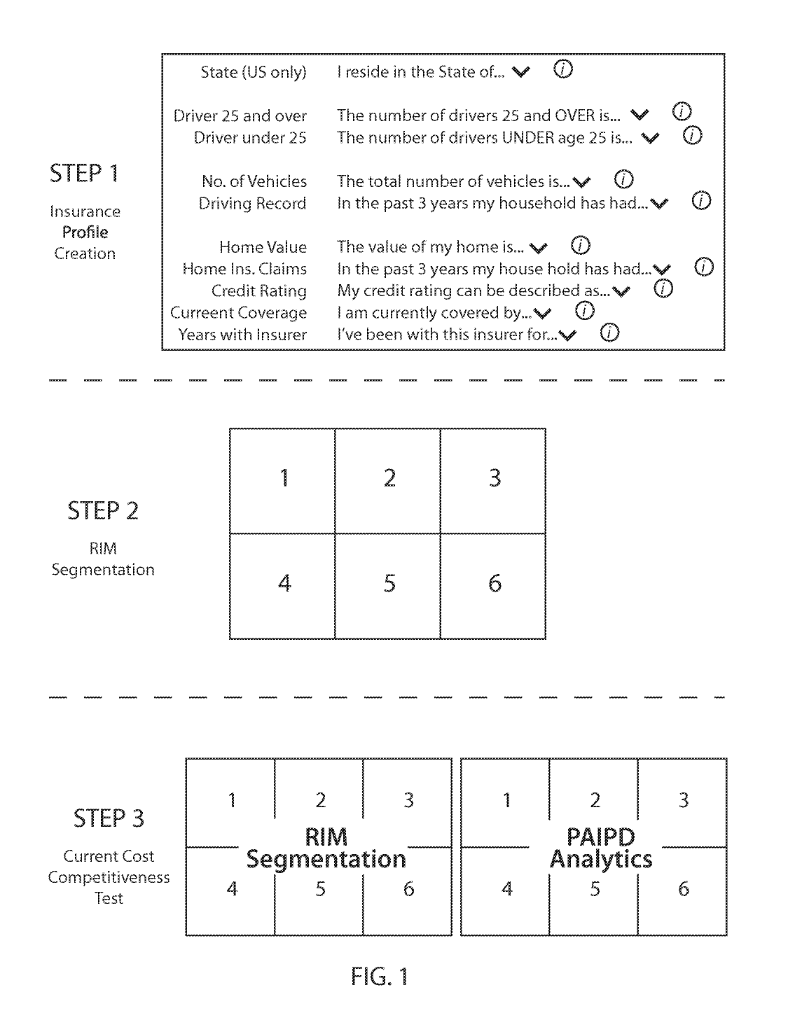

In reference to FIG. 1, the second step of the present invention is the rapid insurance market (RIM) segmentation process. This process is computed by a server or remote computer system utilizing the information components provided by the user in the insurance profile creation process. Once the consumer's insurance profile is determined, the insurance profile can be quickly or instantly placed into a fundamental insurance market segment via the RIM segmentation process.

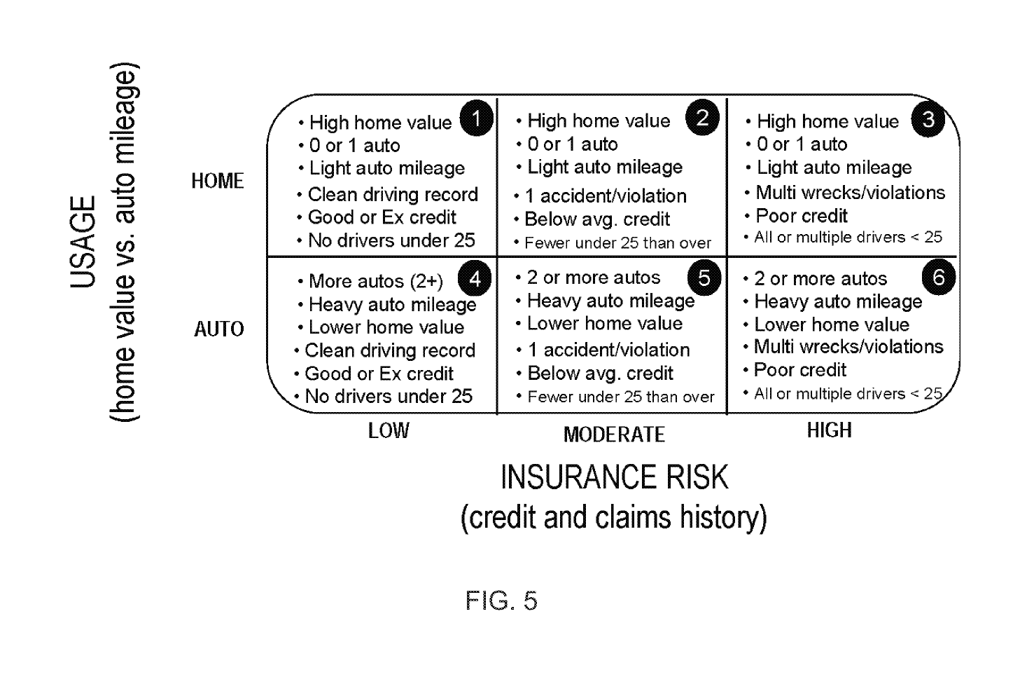

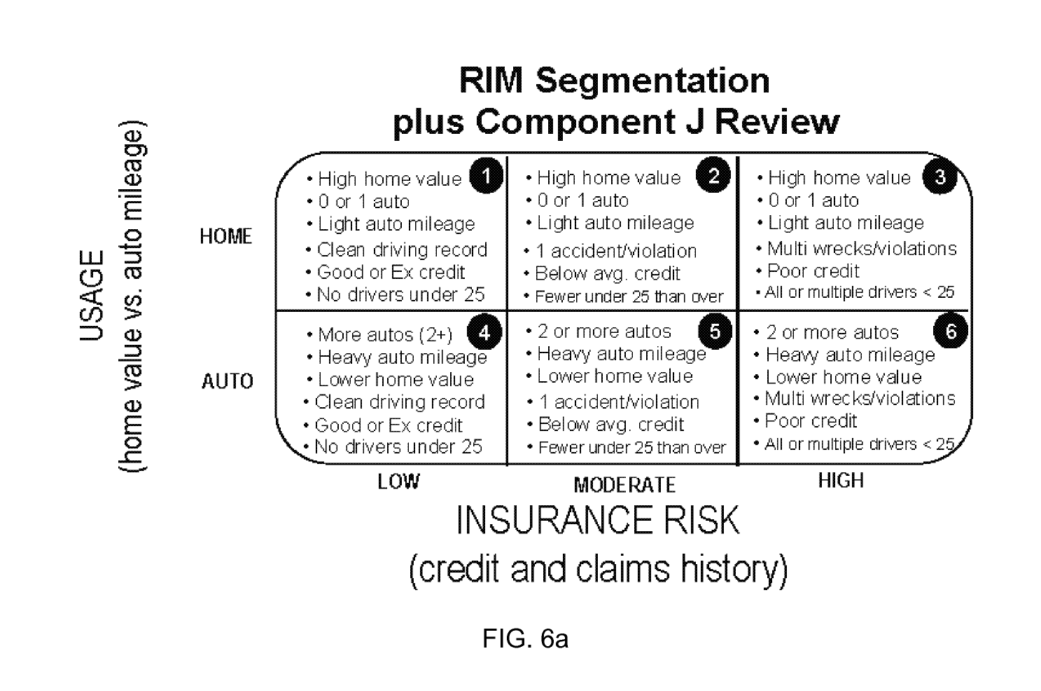

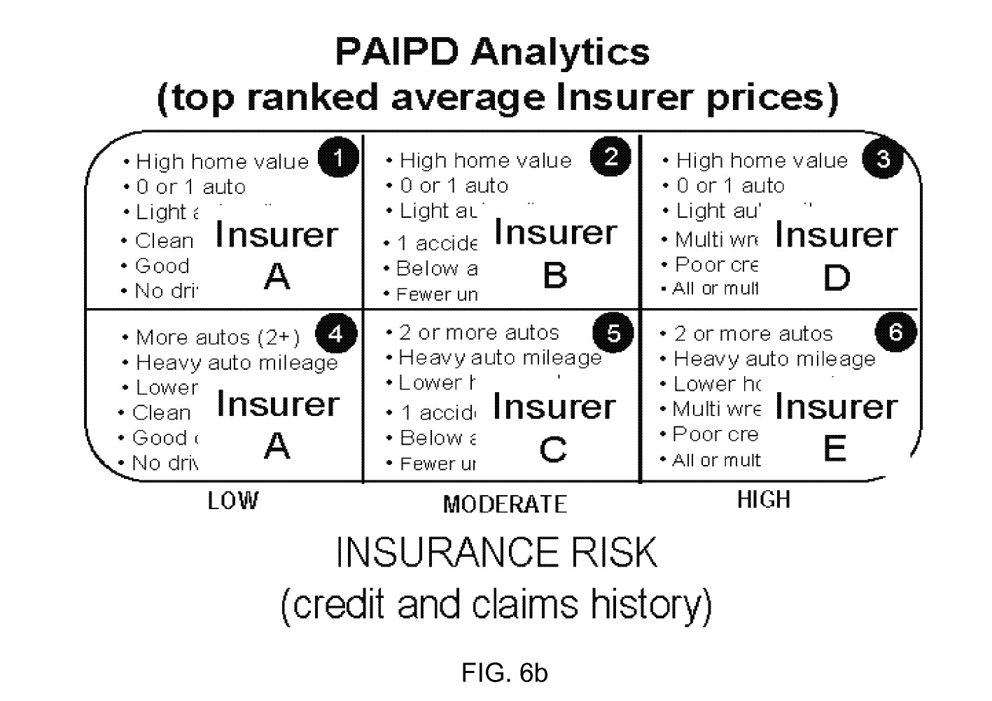

In reference to FIG. 5, the entire matrix shown represents the population of all possible RIM segmentations that can be derived from the information components collected from the consumer. While each of the six segments represents a finite and fundamental subset of consumers' usage of home and auto insurance products across consumers' risk attributes, there are theoretically dozens of sub-segments falling within and between these six market segments. For practical purposes, in this embodiment of the present invention, there are six market segments. Furthermore, while the segmentation process is discussed in the state level, it can also be performed at the city or zip code level as more detailed and granular data becomes available. Each market segment consists of a plurality of informational element ranges to determine the factors that place certain insurance companies within each market segment. A plurality of insurance companies is assigned to their associated market segments dependant on the factors they place weight on when determining insurance premium pricings. The insurance profile of the user is then matched to a market segment accordingly where the insurance needs are most fitted. The insurance profile is matched to one of the market segments based on the plurality of auto elements and the plurality of home elements provided by the user. The matching of insurance profiles to a market segment depends on the combinations of information components B, the component C, the component D, the component E, the component F, the component G, the component H, the information component I, the information component J, and the information component K. The combination of components B, C, D, E, F and I can effectively place the majority of consumers into an auto insurance market segment typically used and typically priced by insurers. The combination of components B, G, H and I can effectively place the majority of consumers into a home insurance market segment typically used and priced by insurers. The combinations of elements B through I can effectively place the majority of consumers into a combined or bundled home and auto insurance market segment typically used and priced by insurers. The market segment for an insurance profile is determined by positioning the summary of the profile information components in a manner similar to what is described for each market segment. Each of the values provided by the consumer defining their insurance profile is matched to the market segment with the value ranges for each component to determine the proper market segment.

The final step of the present invention is the current cost competitiveness test process. This step is computed by a server and/or remote computer system for providing the user with a list of insurance companies ranked by insurance premium pricings. Once the insurance profile of the user is matched with a market segment, the current cost competitiveness for each company within the matched market segment is analyzed. The insurance profile is quickly or instantly matched to an insurance company that offers a very competitive pricing for consumers within the assigned market segment. This step is referred to as the current cost competitiveness test (“CCC test”).

The CCC test is essentially a process of comparison and is accomplished by the following sub-steps:
1) Take the current insurer value from Component J along with the years with insurer from component K of insurance profile creation step and the market segment as determined in the RIM segmentation step.
2) Analyzing publicly available insurer pricing data (PAIPD) and dot plotting numerous pricing data points for the current insurer into the market segments defined in the RIM segmentation process. For example, determine the insurer's price for a 37 year old with no subordinate drivers under the age of 25 years, with 2 vehicles, no accidents or violations in last 3 years, below average home value, no homeowner claims, and excellent credit. In this example, this particular insurer price point would fall into market segment #4 in as shown in FIG. 5.
3) Perform the same PAIPD dot plot analysis for the same Profile (e.g., 37 year old, etc.) for numerous other Insurers and then rank the resulting prices of all Insurers (both current and other) from the lowest price to the highest price for the same Profile. For example, all of these points would fall into Market Segment #4 and would determine which Insurer(s) had the strongest pricing for this one Profile and potentially for similar Profiles falling into Market Segment #4. Perform additional analyses using similar Profiles that would fall into Market Segment #4 and evaluate the average Insurer prices for all data points or Profiles in Market Segment #4. Rank the resulting average Insurer prices from lowest to highest.

4) Determine if the Current Insurer from Step 1 (Component J) equals the top ranked Insurer (i.e., lowest price) from the PAIPD dot plot analyses. If Component J equals the top ranked Insurer, then the CCC Test would suggest that the consumer is already with a low cost Insurer. If Component J does not equal the top ranked Insurer, then the CCC Test would suggest that the consumer has a savings opportunity available by switching to an Insurer that prices their Profile and their Market Segment more aggressively than their Current Insurer does. In effect, is there a match or a mismatch when comparing the Current Insurer of the consumer and the low-cost Insurer for the consumer's specific Profile and Market Segment as determined by analytics of PAIPD.

### Example of Process:

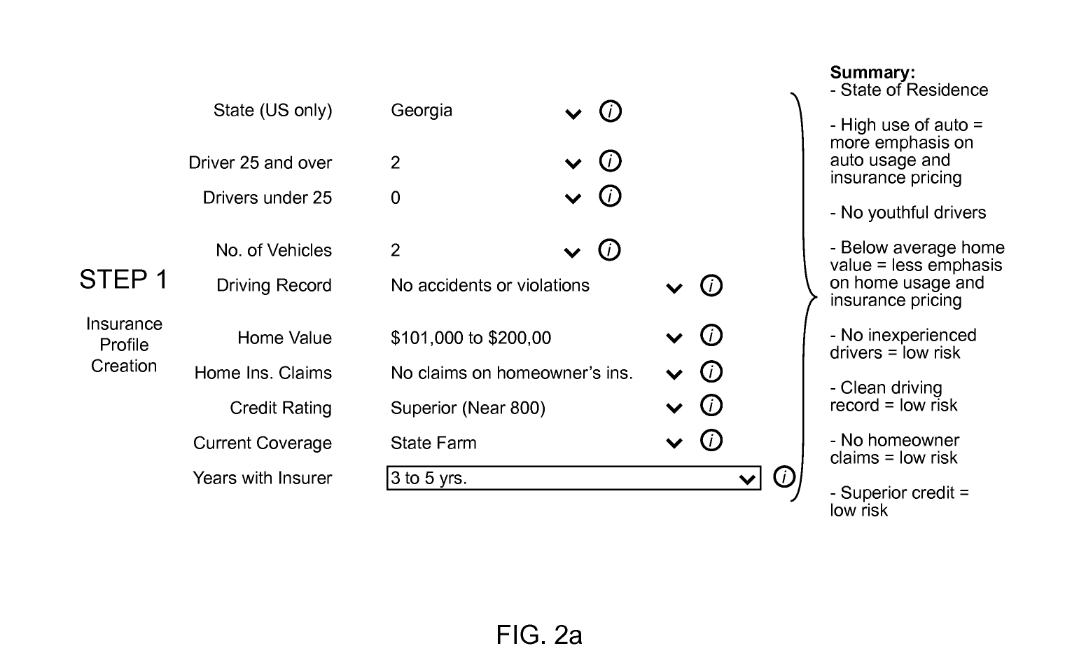

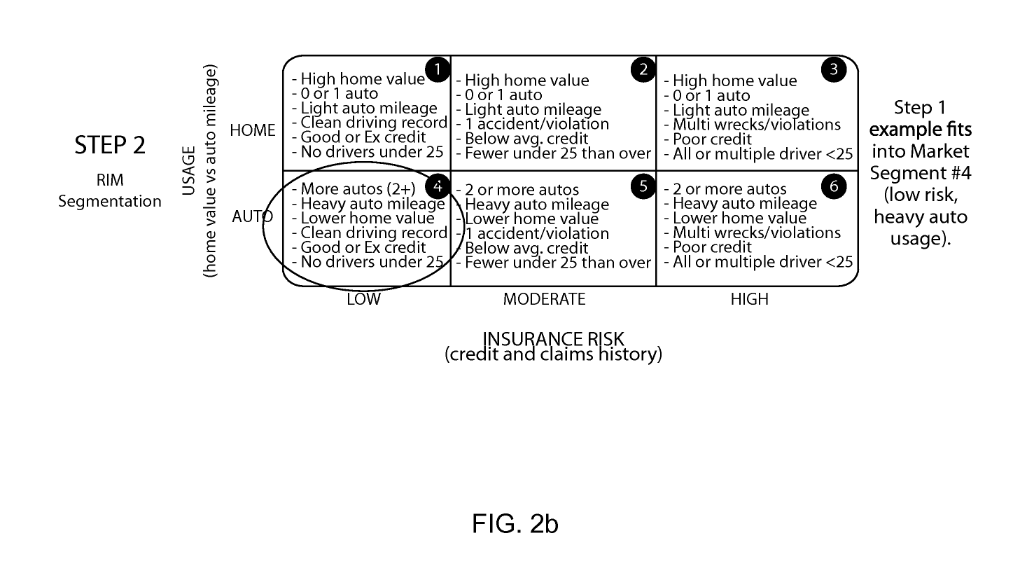

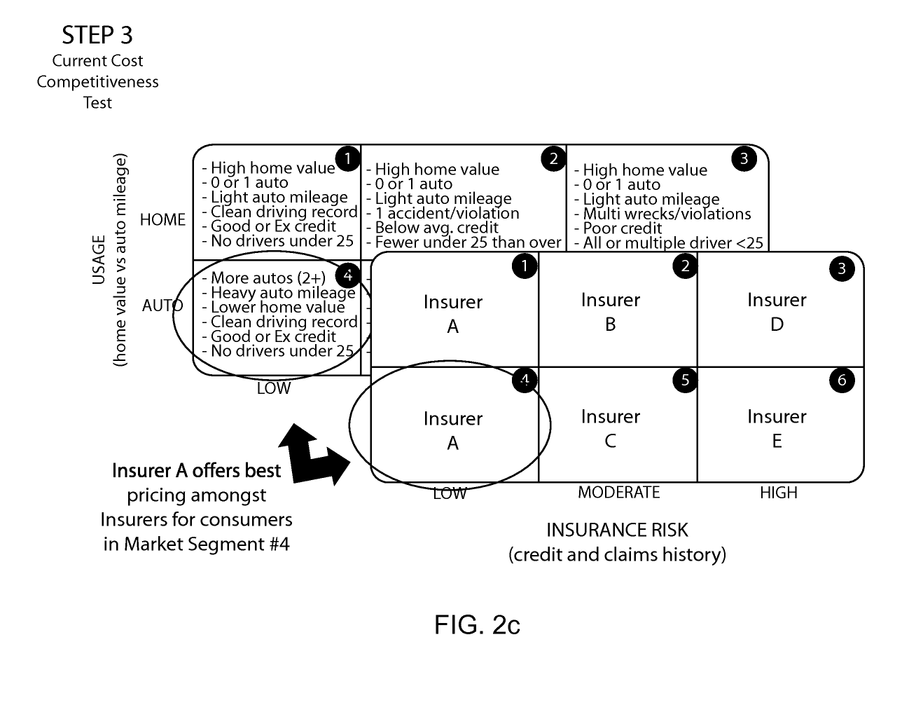

In one embodiment of the present invention, FIG. 2 depicts an example of the complete process.

Step 1 of FIG. 2 represents the creation of a single Insurance Profile as input by a client system and browser on the WWW.

As previously mentioned, I claim that a consumer's Insurance Profile can be effectively determined and understood from 9 Components. These 9 Components represent either an important quantification element of risk for auto or home insurance or a quantification element of usage for auto or home insurance—where I claim risk and usage are the two primary types of Components of insurance costs for Insurers and therefore insurance pricing for consumers. In Step 1 of the FIG. 2 example, the client inputs the Components/values representing:
A consumer living in the state of Georgia
No inexperienced drivers=lower risk of accident and/or violations
Multiple vehicles=more vehicles represents higher usage of autos
A clean driving record=low risk of accident and/or violations
A modest home value=limited home insurance spend relative to auto insurance spend
No home insurance claims=low risk
A strong credit rating=low risk
Currently has Insurer E.

The values just mentioned collectively represent the client's Insurance Profile.

In Step 2 of the FIG. 2 example, the various Components of the consumer's Insurance Profile are summarized so that the Profile can be rapidly placed into the most representative insurance Market Segment. In this example, the consumer selected Components that are representative of and could be generalized as heavy auto insurance usage, light home insurance usage, and a consistently low risk profile for all of the risk components. In the matrix shown in Step 2 of FIG. 2, this Profile fits into the Insurance Market Segment #4.

In Step 3 of the FIG. 2 example, there are two tables of information shown. One represents the consumer Market Segmentation matrix and the other represents segmentation of Insurer pricing data as analyzed from PAIPD. The tables are meant to depict symmetrical Segmentation, that is, both tables of data are segmented according to the same groupings of usage and risk.

In one embodiment of the present invention, Step 3 of FIG. 2 depicts Insurers A, B, C, D, and E as being the best priced Insurer for certain Market Segments or groupings of Insurance Profiles where Insurer A is represented as the best priced Insurer for two different Market Segments (#1 and #4), Insurer B is best for Segment #2, Insurer D for Segment #3, Insurer C for Segment #5, and Insurer E is represented as the best priced Insurer for Segment #6.

Since Step 2 of FIG. 2 positioned the example client Profile into Segment #4, and since PAIPD suggests that Insurer A is the top rated (i.e., lowest priced) option for Segment #4, Insurer A would be matched to the example client.

Lastly, since the example client currently has Insurer E, the result of the CCC Test would be that a savings opportunity exists with Insurer A since Insurer E was not determined to be the top ranked (i.e., lowest price) Insurer for Segment #4.

Although the present invention has been described in terms of various embodiments, it is not intended that the invention be limited to these embodiments. Modification within the spirit of the invention will be apparent to those skilled in the art.

The following Components are typically required for accurate auto and home insurance quoting:
1) Social security number
2) Number of drivers in household
3) Number of vehicles
4) Vehicle ownership status (own, lease)
5) Contact info (email, phone number or both)
6) When would you like the policy to start
7) Has any driver has license suspended or revoked or major violations?
8) How many tickets last 3-5 years
9) How many at-fault violations 3-5 years
10) Has insurance been continuous for some period of time?
11) Date of birth
12) At what age was the driver first licensed?
13) Employment status
14) State of drivers license
15) Drivers license number
16) Car make
17) Car model
18) Car year
19) Car Vehicle Identification Number (V_{IN})
20) Use of vehicle (personal, business, etc)
21) Mileage per year
22) Driving history
23) Where is the vehicle kept
24) Auto security features
25) Air bag option
26) Home address
27) Home city
28) Home state
29) Home zipcode
30) Type of home (condo, single family residence, etc)
31) Roof material
32) Home composition
33) Interior flooring percentages (hardwood %, tile %, carpet %)
34) Number of baths
35) Number of custom rooms (especially bathrooms)
36) Home security features
37) Type of foundation (slab, crawlspace, basement)
38) Finished basement or unfinished
39) What percentage of basement is finished
40) Garage type
41) Garage capacity (1 car, 2 car, 3 car)
42) Have a dog?
43) Smoking status?
44) Marital status
45) Number of people living in the home
46) Distance from fire hydrant
47) Distance from fire station

Some definitions relating to the present invention are as follows:

Insurer: an insurance company that charges premiums to consumers and that makes claim payments to consumers as needed. Insurers are also known commonly throughout the insurance industry as “Carriers”.

Insurance Profile (“Profile”): a set of characteristics for one consumer that represent the consumer's specific characteristic relating to home and auto insurance (including numerous insurance usage and risk components discussed herein).

Market Segment (“Segment”): a grouping of similar consumers sharing similar Insurance Profiles and characteristics.

Component: a specific piece of information or characteristic relating to a measure of consumer insurance risk and/or usage that the invention uses to accomplish its goal. Collectively, the invention uses 10 specific components in concert with one another to accomplish its objective.

Publically Available Insurer Pricing Data (“PAIPD”): data available to the public from actual Insurer quotes to consumers and/or by analyzing Insurer rate table data made available by the Department of Insurance for various states.

Although the invention has been explained in relation to its preferred embodiment, it is to be understood that many other possible modifications and variations can be made without departing from the spirit and scope of the invention as hereinafter claimed.

What is claimed is:

1. A method for quickly determining a consumer's current insurance profile and evaluating a consumer's opportunity to save money on insurance premiums by executing a compute-executable instructions stored on a non-transitory computer-readable medium, the method comprises the steps of:
providing a plurality of market segments, wherein each market segments consists of a plurality of informational element ranges;
assigning of a plurality of insurance companies to a plurality of market segments;
prompting for a plurality of informational elements, wherein the plurality of informational elements include a plurality of auto elements, a plurality of home elements, an information component B, an information component I, an information component J, and an information component K;
defining an insurance profile with the plurality of informational elements;
matching of the insurance profile to one of the market segments based on the plurality of auto elements and the plurality of home elements; and
analyzing current cost competitiveness for each insurance company within the matched market segment.

2. The method for quickly determining a consumer's current insurance profile and evaluating a consumer's opportunity to save money on insurance premiums by executing a computer-executable instructions stored on a non-transitory computer-readable medium, as claimed in claim 1 comprises,
prompting for the plurality of auto elements, wherein the plurality of auto elements comprises a component C, a component D, a component E, and a component F; and
matching of the insurance profile to the plurality of market segments depending on the combination of the information component B, the component C, the component D, the component E, the component F, and the information component I.

3. The method for quickly determining a consumer's current insurance profile and evaluating a consumer's opportunity to save money on insurance premiums by executing a computer-executable instructions stored on a non-transitory computer-readable medium, as claimed in claim 1 comprises,
prompting for the plurality of home elements, wherein the plurality of home elements comprises a component G, a component H; and
matching of the insurance profile to the plurality of market segments depending on the combination of the information component B, the component G, the component H, and the informational component I.

4. The method for quickly determining a consumer's current insurance profile and evaluating a consumer's opportunity to save money on insurance premiums by executing a computer-executable instructions stored on a non-transitory computer-readable medium, as claimed in claim 2 comprises,
wherein the component C is number of drivers over age 25 registered under the insurance profile;
wherein the component D is number of drivers under age 25 registered under the insurance profile;
wherein the component E is number of vehicles registered under the insurance profile; and
wherein the component F is number of at-fault accidents and driving violations within the last 3 years of the entire household recorded on the insurance profile.

5. The method for quickly determining a consumer's current insurance profile and evaluating a consumer's opportunity to save money on insurance premiums by executing a computer-executable instructions stored on a non-transitory computer-readable medium, as claimed in claim 3 comprises,
wherein the component G is value of home registered under the insurance profile; and
wherein the component H is number of claims made for the home within the last 3 years for the home under the insurance profile.

6. The method for quickly determining a consumer's current insurance profile and evaluating a consumer's opportunity to save money on insurance premiums by executing a computer-executable instructions stored on a non-transitory computer-readable medium, as claimed in claim 1 comprises,
wherein the information component B is the state of residence for the insurance profile;
wherein the information component I is a credit score rating of the insurance profile;
wherein the information component J is current coverage of the insurance profile; and
wherein the information component K is number of years insured with current coverage.

7. The method for quickly determining a consumer's current insurance profile and evaluating a consumer's opportunity to save money on insurance premiums by executing a computer-executable instructions stored on a non-transitory computer-readable medium, as claimed in claim 2 comprises,
analyzing a publicly available insurer pricing database by inputting the plurality of home elements and the plurality of auto elements;
plotting a dot analysis of the insurance profile with the numerous insurers assigned under the matched market segment;
displaying of the dot plot analysis with ranking of all insurers based on lowest prices to highest prices within the matched market segment; and
comparing the information component J with the top ranked insurer, wherein equal value between the information component J and the top ranked insurer suggests the current insurer is a low cost insurer.

8. A method for quickly determining a consumer's current insurance profile and evaluating a consumer's opportunity to save money on insurance premiums by executing a compute-executable instructions stored on a non-transitory computer-readable medium, the method comprises the steps of:
providing a plurality of market segments, wherein each market segments consists of a plurality of informational element ranges;
assigning of a plurality of insurance companies to a plurality of market segments;
prompting for a plurality of informational elements, wherein the plurality of informational elements include a plurality of auto elements and a plurality of home elements;
defining an insurance profile with the plurality of informational elements;
matching of the insurance profile to one of the market segments based on the plurality of auto elements and the plurality of home elements; and
analyzing a current cost competitiveness factor for each insurance company within the matched market segment.

9. The method for quickly determining a consumer's current insurance profile and evaluating a consumer's opportunity to save money on insurance premiums by executing a computer-executable instructions stored on a non-transitory computer-readable medium, as claimed in claim 8 comprises,
prompting for the plurality of auto elements; and
matching of the insurance profile to the plurality of market segments depending on the plurality of auto elements.

10. The method for quickly determining a consumer's current insurance profile and evaluating a consumer's opportunity to save money on insurance premiums by executing a computer-executable instructions stored on a non-transitory computer-readable medium, as claimed in claim 8 comprises,
prompting for the plurality of home elements; and
matching of the insurance profiled to the plurality of market segments depending on the plurality of home elements.

11. The method for quickly determining a consumer's current insurance profile and evaluating a consumer's opportunity to save money on insurance premiums by executing a computer-executable instructions stored on a non-transitory computer-readable medium, as claimed in claim 8 comprises,
analyzing a publicly available insurer pricing database by inputting the plurality of home elements and the plurality of auto elements;
plotting a dot analysis of the insurance profile with the numerous insurers assigned under the matched market segment; and
displaying of the dot plot analysis with ranking of all insurers based on lowest prices to highest prices within the matched market segment.

12. A method for quickly determining a consumer's current insurance profile and evaluating a consumer's opportunity to save money on insurance premiums by executing a compute-executable instructions stored on a non-transitory computer-readable medium, the method comprises the steps of:
providing a plurality of market segments, wherein each market segments consists of a plurality of informational element ranges;
assigning of a plurality of insurance companies to a plurality of market segments;
prompting for a plurality of informational elements, wherein the plurality of informational elements include a plurality of auto elements and a plurality of home elements;
defining an insurance profile with the plurality of informational elements;
matching of the insurance profile to one of the market segments based on the plurality of auto elements and the plurality of home elements;
analyzing a current cost competitiveness factor for each insurance company within the matched market segment;
analyzing a publicly available insurer pricing database by inputting the plurality of home elements and the plurality of auto elements;
plotting a dot analysis of the insurance profile with the numerous insurers assigned under the matched market segment; and
displaying of the dot plot analysis with ranking of all insurers based on lowest prices to highest prices within the matched market segment.

13. The method for quickly determining a consumer's current insurance profile and evaluating a consumer's opportunity to save money on insurance premiums by executing a computer-executable instructions stored on a non-transitory computer-readable medium, as claimed in claim 12 comprises,
prompting for the plurality of auto elements;
prompting for the plurality of home elements; and
matching of the insurance profiled to the plurality of market segments depending on the plurality of home elements and the plurality of auto elements.
